(19) United States
(12) Patent Application Publication
(10) Pub. No.: US 2013/0257710 A1
(43) Pub. Date: Oct. 3, 2013

(54) IMAGE DISPLAY SYSTEM AND METHOD OF DRIVING THE SAME

(71) Applicants: Won Sik Oh, Seoul (KR); JinHo Park, Suwn-si (KR); Yunki Baek, Suwon-si (KR); Gigeun Kim, Seoul (KR)

(72) Inventors: Won Sik Oh, Seoul (KR); JinHo Park, Suwn-si (KR); Yunki Baek, Suwon-si (KR); Gigeun Kim, Seoul (KR)

(73) Assignee: Samsung Display Co., Ltd., Yongin-City (KR)

(21) Appl. No.: 13/604,226

(22) Filed: Sep. 5, 2012

(30) Foreign Application Priority Data
Mar. 28, 2012 (KR) 10-2012-0031868

(51) Int. Cl. G09G 5/00

(52) U.S. Cl. 345/156

(57) ABSTRACT

An image display system includes a sensor part, a camera part, and an image display part. The sensor part is configured to sense a presence of a user and output a sensing signal. The camera part is configured to be controlled by the sensing signal, detect an eye direction of the user, and output a detecting signal. The image display part is configured to be operated in one of first, second, and third modes on the basis of the sensing signal and the detecting signal. The sensor part and the camera part are operated independently from the image display part. Power consumption becomes smaller in order of the first mode, the second mode, and the third mode.

### CROSS-REFERENCE TO RELATED APPLICATION

This U.S. non-provisional patent application claims priority from and the benefit of Korean Patent Application No. 10-2012-0031868, filed on Mar. 28, 2012, which is incorporated by reference in its entirety as if set forth in full.

### BACKGROUND

1. Field

Exemplary embodiments of the invention relate to an image display system and a method of driving the same. More particularly, exemplary embodiments of the invention relate to an image display system operated in various modes according to user's presence and the direction of user's eyes and a method of driving the image display system.

2. Discussion of the Background

Various display devices, such as a computer monitor, a mobile phone, a television set, etc., have been developed.

When a user does not use the above-mentioned display devices, the display devices may be switched to a power saving mode or a standby mode in order to reduce power consumption.

In general, when the display devices are in the power saving mode or in the standby mode, the user needs to manually operate the display devices in order to use the display devices again. In addition, even when the user is using the display devices, the display devices may switch to the power saving mode or to the standby mode when there is no input.

The above information disclosed in this Background section is only for enhancement of understanding of the background of the invention and therefore it may contain information that does not form any part of the prior art nor what the prior art may suggest to a person of ordinary skill in the art.

### SUMMARY

Accordingly, there is a need for an improved image display system and a method of driving the image display system that may obviate one or more of the above-mentioned problems or disadvantages. In particular, there is a need for an improved image display system and a method of driving the image display system which may operate in various modes and automatically switch between the modes according to user's presence and the direction of the user's eyes.

Additional features of the invention will be set forth in the description which follows, and in part will be apparent from the description, or may be learned by practice of the invention.

In one exemplary aspect of the present invention, an image display system may include a sensor part configured to sense a presence of a user and output a sensing signal, a camera part configured to be controlled by the sensing signal, detect an eye direction of the user, and output a detecting signal, and an image display part configured to be controlled by the sensing signal and the detecting signal. The sensor part and the camera part are operated independently from the image display part.

In another aspect of the present invention, a method of driving an image display system may include sensing existence presence of a user, detecting an eye direction of the user, and operating an image display part in a first mode, a second mode, or a third mode according to the sensing result or the sensing and detecting results.

In another aspect of the present invention, an image display system including a first sensor configured to sense a presence of a user and to output a first signal indicating whether the user is present, a second sensor configured to detect a physical characteristic of the user in response to receiving the first signal and to output a second signal according to a state of the detected physical characteristic, and an image display part configured to operate according to the second signal. The first sensor and the second sensor are powered independently from the image display part.

According to the above, the image display system is operated in various operation modes in accordance with the existence of the user and the user's eye direction, and thus the power consumption of the image display system may be reduced. In addition, the switching operation between the various modes is automatically performed.

The operation of the image display system is performed by the above-mentioned driving method of the image display system.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various embodiments consistent with the invention and, together with the description, serve to explain the principles of the invention.

FIG. 1 is an exploded perspective view showing an image display system according to an exemplary embodiment of the present invention;

FIG. 2 is a block diagram illustrating an exemplary operation of the image display system.

FIG. 3 is a flowchart illustrating an exemplary operation of the image display system operated in first, second, and third modes.

### DETAILED DESCRIPTION OF THE ILLUSTRATED EMBODIMENTS

Reference will now be made in detail to the exemplary embodiments consistent with the present disclosure, examples of which are illustrated in the accompanying drawings. Wherever possible, the same reference characters will be used throughout the drawings to refer to the same or like parts.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

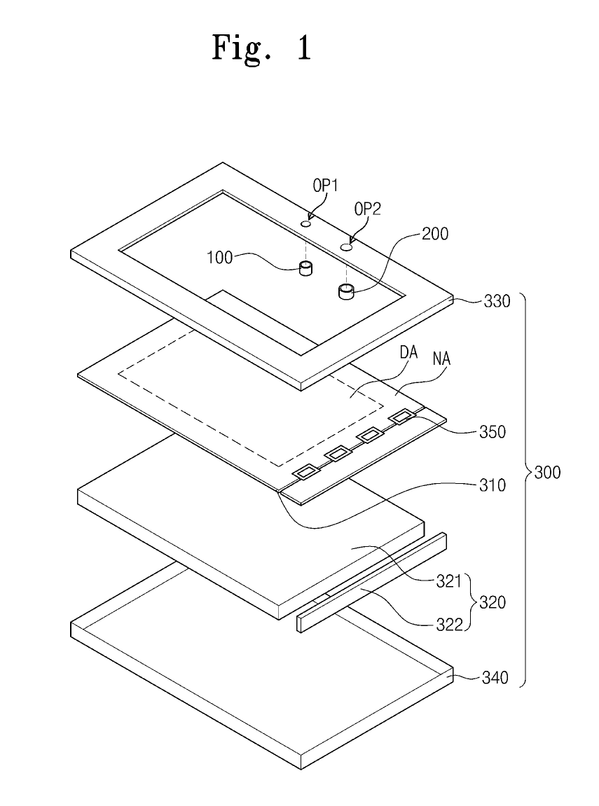

FIG. 1 is an exploded perspective view showing an image display system according to an exemplary embodiment of the present invention.

Referring to FIG. 1, the image display system includes a sensor part 100, a camera part 200, and an image display part 300.

The image display part 300 includes a display panel 310, a backlight unit 320, an upper cover 330, and a lower cover 340.

The display panel 310 displays an image. The display panel 310 includes a display area DA and a non-display area NA adjacent to at least a portion of the display area DA. The display panel 310 may be, but not limited to, an organic light emitting display panel, a liquid crystal display panel, a plasma display panel, an electrophoresis display panel, or an electrowetting display panel. In the present exemplary embodiment, the liquid crystal display will be described as the display panel 310.

Although not shown in FIG. 1, the display panel 310 includes a lower substrate, an upper substrate facing the lower substrate, and a liquid crystal layer interposed between the lower substrate and the upper substrate.

The lower substrate includes gate lines, data lines crossing the gate lines, and pixel electrodes. The lower substrate includes pixel areas arranged in a matrix form, and pixels are arranged in the pixel areas, respectively. Each pixel includes a thin film transistor, a liquid crystal capacitor, and a storage capacitor. The thin film transistor is connected to a corresponding gate line and a corresponding data line and applies a data voltage to the pixel electrode in response to a gate-on signal.

The upper substrate includes a common electrode applied with a reference voltage. The liquid crystal layer disposed between the pixel electrode and the common electrode serves as a dielectric substance. The liquid crystal capacitor is charged with a voltage corresponding to an electric potential difference between the data voltage and the reference voltage. In addition, the upper substrate may include a color filter layer.

In addition, the image display system includes a driving circuit part 350 disposed adjacent to a side of the display panel 310. The driving circuit part 350 receives a data signal and a control signal from an external device (not shown).

The backlight unit 320 provides light to the display panel 310. The backlight unit 320 includes an optical member 321 and a light source 322. The optical member 321 includes a light guide plate, a diffusion sheet, and a reflection sheet. The light source 322 emits the light to the optical member 321. In FIG. 1, the light source 322 is disposed adjacent to one side of the optical member 321, but the position of the light source 322 should not be limited thereto or thereby. For example, the light source 322 may be disposed under the optical member 321.

The light source 322 may be, but not limited to, a light emitting diode (LED) or a cold cathode fluorescent lamp (CCFL). In cases where the display panel 310 is the organic light emitting display panel or the plasma display panel, the backlight unit 320 may be omitted since each of the organic light emitting display panel and the plasma display panel is a self-emissive type display panel.

The upper cover 330 and the lower cover 340 accommodate the display panel 310 and the backlight unit 320. The upper cover 330 and the lower cover 340 are disposed at positions corresponding to at least the non-display area NA of the display panel 310. In the present exemplary embodiment, each of the upper and lower covers 330 and 340 is formed in a single body as shown in FIG. 1, but the structure of the covers 330 and 340 should not be limited to a single body. For example, each of the upper and lower covers 330 and 340 may include two or more members coupled to each other.

The upper cover 330 and the lower cover 340 further accommodate the sensor part 100 and the camera part 200.

The upper cover 330 includes a first opening OP1 and a second opening OP2. The first opening OP1 and the second opening OP2 are positioned corresponding to the non-display area NA. The sensor part 100 is exposed through the first opening OP1 and the camera part 200 is exposed through the second opening OP2.

The sensor part 100 is disposed to correspond to the first opening OP1.

The sensor part 100 senses the presence of the user. Although not shown in FIG. 1, the sensor part 100 may include an infrared-ray sensor. The infrared-ray sensor includes an infrared-ray generator (not shown) and infrared-ray receiver (not shown). The infrared-ray generator emits the infrared ray in a front direction of the image display part 300 from the inside of the image display part 300. The infrared-ray receiver receives a portion of the infrared-ray reflected by the user. The infrared-ray sensor determines whether the user is present according to the amount of the infrared ray received by the infrared-ray receiver.

The camera part 200 is disposed to correspond to the second opening OP2.

The camera part 200 may be controlled by the sensed value of the sensor part 100. In detail, when the sensor part 100 determines that the user is present, a power supply voltage may be applied to the camera part 200. The camera part 200 may detect the direction of the user's eyes. To this end, the camera part 200 may take a picture of the user's face and analyze the user's face from the picture to detect the direction of the user's eyes. In more detail, when the camera part 200 detects that the direction of the user's eyes (gaze) is in the direction of the front side of the image display part 300, it is determined that the user is watching the image display part 300. Similarly, it is determined that the user is not watching the image display part 300 when the direction of the user's eyes is not in the direction of the front side of the image display part 300.

The sensor part 100 and the camera part 200 may be independently operated from the image display part 300. For instance, the sensor part 100 and the camera part 200 are applied with a power supply voltage separate from the voltage applied to the image display part 300. Accordingly, the sensor part 100 and the camera part 200 may maintain in an ON state even though the image display part 300 is turned off.

As shown in FIG. 1, the sensor part 100 and the camera part 200 are accommodated in the upper and lower covers 330 and 340, but they should not be limited thereto or thereby. That is, the sensor part 100 and the camera part 200 may be attached to the image display part 300 independent from the image display part 300. For example, the sensor part 100 and the camera part 200 may be configured to be attachable to detachable from the image display part 300.

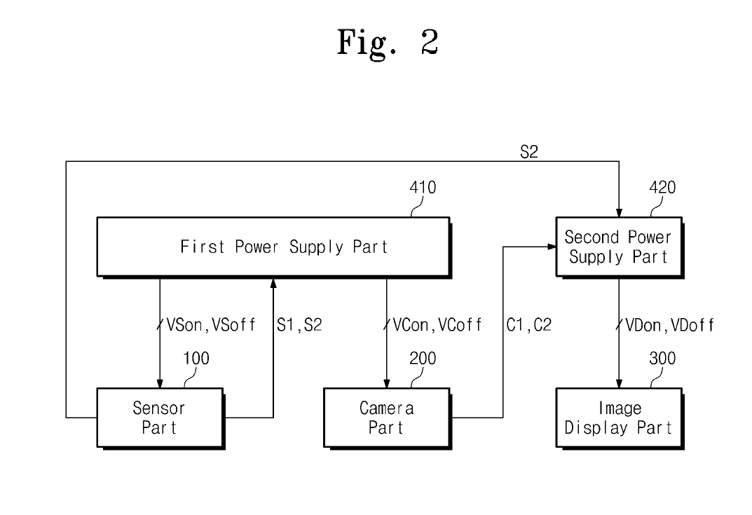

FIG. 2 is a block diagram illustrating an exemplary operation of the image display system.

Referring to FIG. 2, the sensor part 100 senses the presence of the user and outputs a first sensing signal S1 and a second sensing signal S2 according to the sensed result. In detail, when the user is present within a threshold distance from the front side of the image display part 300, the sensor part 100 outputs the first sensing signal S1. By contrast, the sensor part 100 outputs the second sensing signal S2 when the user is not present within the threshold distance.

The camera part 200 may output a first detecting signal C1 when the direction of the user's eyes is in the direction of the image display part 300. By contrast, the camera part 200 may output a second detecting signal C2 when the direction of the user's eyes is not in the direction of the image display part 300. The image display system may further include a first power supply part 410 and a second power supply part 420. The first power supply part 410 applies the power supply voltage to the sensor part 100 and the camera part 200. In detail, the first power supply part 410 applies a sensor-on voltage VSon or a sensor-off voltage VS off to the sensor part 100 to turn on or turn off the sensor part 100. In addition, the first power supply part 410 applies a camera-on voltage VCon or a camera-off voltage VCoff to the camera part 200 to turn on or turn off the camera part 200. The first power supply part 410 may be an embedded type battery or a power supply device separated from the second power supply part 420. The second power supply part 420 applies a driving-on voltage VDon or a driving-off voltage VDoff to the image display part 300 to turn on or turn off the image display part 300.

Since the first power supply part 410 and the second power supply part 420 are electrically separated from each other, the sensor part 100 and the camera part 200 may be operated independently from the image display part 300. The image display part 300 is operated in a first mode, a second mode, or a third mode on the basis of the first sensing signal S1, the second sensing signal S2, the first detecting signal C1, and the second detecting signal C2.

Hereinafter, an exemplary operation of the image display part 300 operated in the first mode will be described.

The image display part 300 is operated in the first mode when the user is present and the direction of user's eye is actually in the direction of the image display part 300.

The sensor part 100 is turned on in response to the sensor-on voltage VSon and senses the presence of the user to apply the first sensing signal S1 to the first power supply part 410. When the first sensing signal S1 is output from the sensor part 100, the first power supply part 410 applies the camera-on voltage VCon to the camera part 200 to turn on the camera part 200. The camera part 200 recognizes the user's face and determines that the direction of user's eye is toward the image display part 300, then the camera part 200 outputs the first detecting signal C1 to the second power supply part 420. When the first detecting signal C1 is output from the camera part 200, the second power supply part 420 applies the driving-on voltage VDon to the image display part 300 to operate the image display part 300. The image display part 300 displays the image at brightness to be perceived to the user. During the operation in the first mode, the sensor part 100, the camera part 200, and the image display part 300 are operated in the turn-on state, thereby causing power consumption.

Hereinafter, an exemplary operation of the image display part 300 operated in the second mode will be described.

When the user is present but the direction of the user's eye is not in the direction of the image display part 300, the image display part 300 is operated in the second mode.

The sensor part 100 is turned on in response to the sensor-on voltage VSon and senses the presence of the user to apply the first sensing signal S1 to the first power supply part 410. When the first sensing signal S1 is output from the sensor part 100, the first power supply part 410 applies the camera-on voltage VCon to the camera part 200 to turn on the camera part 200. The camera part 200 recognizes the user's face and determines that the direction of the user's eye is not in the direction of the image display part 300, then, the camera part 200 outputs the second detecting signal C2 to the second power supply part 420. When the second detecting signal C2 is output from the camera part 200, the second power supply part 420 applies the driving-off voltage VDoff to the image display part 300 to turn off the image display part 300. When the second detecting signal C2 is output from the camera part 200, the image display part 300 may be promptly turned off, but the operation of the image display part 300 should not be limited thereto or thereby. For example, the image display part 300 may be turned off after a predetermined time lapses from the output timing of the second detecting signal C2.

During the second mode, the image display part 300 may not display the image. In addition, the sensor part 100 and the camera part 200 are operated in the turn-on state during the second mode and the image display part 300 is maintained in the turn-off state during the second mode. Thus, the sensor part 100 and the camera part 200 cause the power consumption and the image display part 300 does not cause the power consumption.

Hereinafter, an exemplary operation of the image display part 300 operated in the third mode will be described.

The third mode is activated when the user is not present or the image display part 300 is operated in the second mode over a predetermined time period.

The case where the user is not present will be described. The sensor part 100 is turned on in response to the sensor-on voltage VS on. Then, the sensor part 100 determines that the user is not present within a threshold distance from the front side of the image display part 300 when the amount of the infrared ray, which is provided to the sensor part 100, is lower than a reference value. In this case, the sensor part 100 applies the second sensing signal S2 to the first power supply part 410 and the second power supply part 420. When the second sensing signal S2 is output from the sensor part 100, the first power supply part 410 applies the camera-off voltage VCoff to the camera part 200 and the camera part 200 is turned off in response to the camera-off voltage VCoff. In addition, when the second sensing signal S2 is output from the sensor part 100, the second power supply part 420 applies the driving-off voltage VDoff to the image display part 300 and the image display part 300 is turned off in response to the driving-off voltage VDoff. When the second sensing signal S2 is output from the sensing part 100, the image display part 300 may be promptly turned off, but the operation of the image display part 300 should not be limited thereto or thereby. For example, the image display part 300 may be turned off after a predetermined time lapses from the output timing of the second sensing signal S2.

During the operation in the third mode, the image display part 300 may not display the image. In addition, the sensor part 100 is operated in the turn-on state during the third mode and the camera part 200 and the image display part 300 are maintained in the turn-off state during the operation in the third mode. Thus, the sensor part 100 causes the power consumption and the camera part 200 and the image display part 300 do not cause the power consumption.

Then, when the image display part 300 is operated in the second mode over the predetermined time period, the image display part 300 may be operated in the third mode. The predetermined time period may be previously set in the image display part 300 by the user.

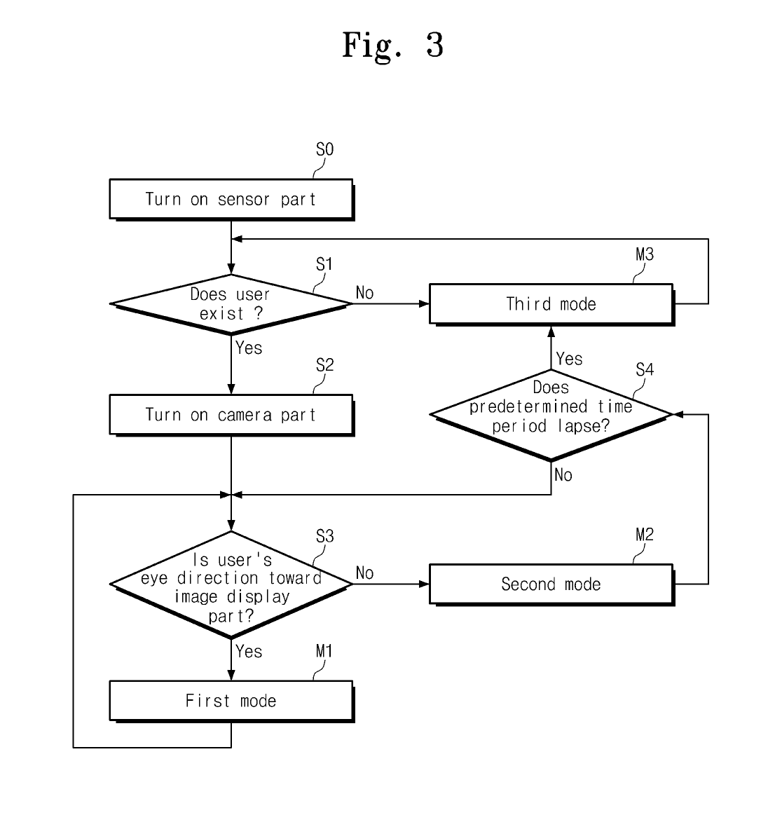

FIG. 3 is a flowchart illustrating an exemplary operation of the image display system operated in the first, second, and third modes.

Referring to FIGS. 2 and 3, the sensor-on voltage VSon is applied to the sensor part 100 to turn on the sensor part 100 (S0).

Then, the sensor part 100 checks whether the user is present within a threshold distance from the front side of the image display part 300 (S1). When the user is not present within the threshold distance according to the checked result, the image display part 300 is operated in the third mode (M3). During the operation in the third mode, the image display part 300 and the camera part 200 are turned off, and thus only the sensor part 100 causes the power consumption.

On the other hand, when the user is present within the threshold distance according to the checked result, the camera-on voltage VCon is applied to the camera part 200 and the camera part 200 is turned on (S2).

Then, the camera part 200 checks whether the direction of the user's eye is in the direction of the image display part 300 or not (S3). When the direction of the user's eye is not in the direction of the image display part 300 according to the checked result, the image display part 300 is operated in the second mode. During the operation of the second mode, the image display part 300 is turned off, so only the sensor part 100 and the camera part 200 cause the power consumption (M2). After that, it is checked whether the image display part 300 is operated in the second mode over the predetermined time period or not (S4). When the image display part 300 is operated in the second mode over the predetermined time period according to the checked result, the image display part 300 is operated in the third mode (M3). On the contrary, when the image display part 300 is not operated in the second mode over the predetermined time period according to the checked result, the camera part 200 checks whether the direction of the user's eye is in the direction of the image display part 300 or not (S3).

When the direction of the user's eye is in the direction of the image display part 300 according to the checked result, the image display part 300 is operated in the first mode (M1). During the operation of the first mode, the sensor part 100, the camera part 200, and the image display part 300 cause the power consumption.

The image display system is operated in the first mode, the second mode, or the third mode according to the presence of the user and the direction of the user's eye, thereby reducing the power consumption. In addition, since the switching operation of the first mode, the second mode, and the third mode are automatically performed, no separate input by the user is required.

In addition, the sensor part 100 and the camera part 200 are applied with the power supply voltage separately from the voltage supply for the image display part 300, so that the image display system may reduce the power consumption. For example, in a case when the sensor part 100, the camera part 200, and the image display part 300 are operated using the same power supply voltage, the power consumption is about 21 W during a predetermined time period, and the power consumption is about 11 W when only the image display part 300 is operated during the predetermined time period. On the contrary, in a case when the sensor part 100 and the camera part 200 are applied with the power supply voltage separately from the voltage supply for the image display part 300, the power consumption caused by the sensor part 100 and the camera part 200 is about 0.5 W during the predetermined time period.

Accordingly, the image display system may reduce the power consumption of about 9.5 W/h when compared with the power consumption caused when the sensor part 100, the camera part 200, and the image display part 300 are operated using the same power supply voltage.

In the present exemplary embodiment, the image display part 300 is turned off in the second mode or the third mode, but the image display part 300 may display the image according to the other embodiments.

For example, referring to FIG. 2 again, when the second detecting signal C2 is output in the second mode or the third mode, the second power supply part 420 applies the driving-on voltage VDon to the image display part 300 to operate the image display part 300. The image display part 300 may display the image at the brightness lower than that of the image displayed in the first mode. For instance, the brightness of the image displayed in the second mode or the third mode is about 70% or more lower than the brightness of the image displayed in the first mode. Thus, the power consumption caused when the image display part 300 is operated in the second mode or the third mode is lower than the power consumption caused when the image display part 300 is operated in the first mode.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An image display system, comprising:
a sensor part configured to sense a presence of a user and output a sensing signal;
a camera part configured to be controlled by the sensing signal, detect an eye direction of the user, and output a detecting signal; and
an image display part configured to be controlled by the sensing signal and the detecting signal, wherein the sensor part and the camera part are operated independently from the image display part.

2. The image display system of claim 1, wherein the sensor part and the camera part are configured to be applied with a power supply voltage separate from the image display part.

3. The image display system of claim 1, wherein the image display part is configured to be operated in one of a first mode, a second mode, and a third mode.

4. The image display system of claim 3, wherein a power consumption of the image display system becomes smaller in order of the first mode, the second mode, and the third mode.

5. The image display system of claim 4, wherein the image display part is configured to be operated in the first mode when the sensor part senses that the user is present and the camera part detects that the eye direction of the user is in the direction of the image display part.

6. The image display system of claim 5, wherein the sensor part, the camera part, and the image display part are configured to be operated in a turn-on state during the first mode.

7. The image display system of claim 4, wherein the image display part is configured to be operated in the second mode when the sensor part senses that the user is present and the camera part detects that the direction of the user's eye is not in the direction of the image display part.

8. The image display system of claim 7, wherein the sensor part and the camera part are configured to be operated in a turn-on state during the second mode.

9. The image display system of claim 4, wherein the image display part is configured to be operated in the third mode when the sensor part senses that the user is not present.

10. The image display system of claim 9, wherein the sensor part is configured to be operated in a turn-on state during the third mode and the camera part is configured to be turned off during the third mode.

11. The image display system of claim 4, wherein the image display part is configured to be turned off during the second mode and the third mode.

12. The image display system of claim 4, wherein the image display part is configured to be operated in the third mode when the image display part is operated in the second mode over a predetermined time period.

13. The image display system of claim 1, wherein the image display part comprises:
a display panel configured to display an image; and
a driving circuit part configured to drive the display panel.

14. A method of driving an image display system, comprising:
sensing a presence of a user;
detecting an eye direction of the user; and
operating an image display part in a first mode, a second mode, or a third mode according to the sensing result or the sensing and detecting results.

15. The method of claim 14, wherein a power consumption of the image display system becomes smaller in order of the first mode, the second mode, and the third mode.

16. The method of claim 15, wherein the image display part is configured to be operated in the first mode when the user is present and the eye direction of the user is in the direction of the image display part.

17. The method of claim 15, wherein the image display part is configured to be operated in the second mode when the user is present and the eye direction of the user is not in the direction of the image display part.

18. The method of claim 15, wherein the image display part is configured to be operated in the third mode when the user is not present or the image display part is operated in the second mode over a predetermined time period.

19. An image display system, comprising:
A first sensor configured to sense a presence of a user and to output a first signal indicating whether the user is present;
a second sensor configured to detect a physical characteristic of the user in response to receiving the first signal and to output a second signal according to a state of the detected physical characteristic; and
an image display part configured to operate according to the second signal,
wherein the first sensor and the second sensor are powered independently from the image display part.

20. The image display system of claim 19, wherein the first sensor comprises an infrared-ray sensor and the second sensor comprises a camera.
